(19) United States
(12) Patent Application Publication
(10) Pub. No.: US 2021/0201258 A1
(43) Pub. Date: Jul. 1, 2021

(54) SYSTEM AND METHOD FOR DELIVERY CONFIRMATION USING A LOCAL DEVICE FOR OPTICAL SCANS

(71) Applicant: United Parcel Service of America, Inc., Atlanta, GA (US)

(72) Inventor: Juan Perez, Milton, GA (US)

(21) Appl. No.: 17/130,160

(22) Filed: Dec. 22, 2020

Related U.S. Application Data
(60) Provisional application No. 62/954,063, filed on Dec. 27, 2019.

(51) Int. Cl. G06Q 10/08; G06K 19/06

(52) U.S. Cl. CPC G06Q 10/0833; G06K 19/06028

(57) ABSTRACT

Computer program products, methods, systems, apparatus, and computing entities are provided. In one aspect, a connection between an electronic door hanger and a customer computing entity can be established at a customer's location. With a connection established, information about an attempted (e.g., successful/unsuccessful) pick-up or delivery can be automatically provided to the customer computing entity.

### CROSS-REFERENCE TO RELATED APPLICATIONS

This application claim the benefit of and priority to U.S. Provisional App. No. 62/954,063, entitled “SYSTEM AND METHOD FOR DELIVERY CONFIRMATION USING A LOCAL DEVICE FOR OPTICAL SCANS” and filed on Dec. 27, 2019, the entirety of which is incorporated by reference herein.

### BACKGROUND

With the increasing demand of customer-focused pick-ups and deliveries of items, new technologies are needed for communicating relevant information to customers in a timely and easy to use manner.

### SUMMARY

In general, aspects of the present invention provide methods, apparatus, systems, computing devices, computing entities, and/or the like for facilitating pick-up and delivery confirmations. In aspects herein, a third-party local computing device that is communicatively coupled to a camera is leveraged to capture and generate a digital image of a computer-readable identifier within a shipping label for an item being picked up or delivered at a delivery location. The third party local computing device decodes the computer-readable identifier from the shipping label in the digital image and sends a notification indicating the pick-up or delivery of the item, in aspects. As such, the third party local computing device is used to “scan” a shipping label provide pick-up or delivery confirmations. By exploiting a third party local computing devices existing at delivery locations in this manner, such a smart doorbell which can communicate direct or indirectly with a carrier computing device via a network, a carrier entity can document and confirm pick-up and delivery of items without requiring personnel to carry mobile devices.

In accordance with one aspect, one or more non-transitory computer-readable storage media having computer-readable instructions embodied therein for execution by one or more processors to perform a method are provided. In one aspect, the method comprises receiving a digital image captured by a local computing device at an end-point location. Then, in aspects, a computer-readable identifier is identified in the digital image. The computer-readable identifier is decoded, for example, by a local computing device, in some aspects. A notification is communicated to a carrier computing device, wherein the notification includes the computer-readable identifier that was decoded.

In accordance with another aspect, one or more non-transitory computer-readable storage media having computer-readable instructions embodied therein for execution by one or more processors to perform a method are provided. The method comprises generating a digital image at a local computing device located at a delivery location, in aspects. A computer-readable identifier, in some aspects, is identified in the digital image. In an aspect, the computer-readable identifier is extracted from the digital image. The computer-readable identifier is decoded, in aspects, and a notification that includes the computer-readable identifier is generated. Then, in an aspect, the notification is sent to a carrier computing device.

In accordance with yet another aspect, a system is provided. The system comprises a local computing device communicatively coupled to a network and running a computer application, in some aspects. In aspects, the system includes a camera that is communicatively coupled to the local computing device. Further, the system comprises a carrier computing device communicatively coupled to the network, in various aspects. The local computing device, in aspects, is configured to generate a digital image using the camera located at a delivery location and identify a computer-readable identifier when present in the digital image. In aspects, the local computing device extracts the computer-readable identifier from the digital image and decodes the computer-readable identifier using the computer application. Then, in some aspects, the local computing devices generates a notification that includes the computer-readable identifier and sends the notification to the carrier computing device via the network.

### BRIEF DESCRIPTION OF THE DRAWINGS

Having thus described the invention in general terms, reference will now be made to the accompanying drawings, which are not necessarily drawn to scale, and wherein:

FIG. 1 is an overview of an environment that is suitable for implementation of the aspects discussed herein;

FIG. 2 is an example flowchart of a method in accordance with aspects herein; and

FIG. 3 is an example flowchart of a method in accordance with aspects herein.

### DETAILED DESCRIPTION

Various aspects of the present invention now will be described more fully hereinafter with reference to the accompanying drawings, in which some, but not all aspects of the inventions are shown. Indeed, these inventions may be embodied in many different forms and should not be construed as limited to the aspects set forth herein; rather, these aspects are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

Aspects herein provide a system, method, and computer-readable media that facilitate a back-end carrier infrastructure (e.g., carrier computing device) leveraging a host of existing devices located as delivery points (e.g., residential or business) in the communication chain for package pick-up and delivery. The devices located at delivery locations, end-point locations, and/or pick-up or delivery stops, referred to as local computing devices, are configured and controlled to remotely communicate with a carrier computing device, in some aspects, that is centralized and/or in the back-end carrier infrastructure. Specifically, a local computing device coupled to a camera and located at a delivery point can obtain a digital image of an item being delivered, for example, as well as personnel, an unmanned aerial vehicle, and/or other vehicle associated with the item's delivery to the end-point location. The local computing device and/or the carrier computing device can analyze the digital image to locate a shipping label and decode a computer-readable identifier thereon. The local computing device and/or the carrier computing device can locate a shipping record for the item, as associated with computer-readable identifier that was captured or “scanned” using the camera coupled to the local computing device. Further, the local computing device and/or the carrier computing device can generate and transmit an notification confirming the item's delivery, based on consignee contact preferences and information stored in association with the shipping record for the item that was locate using the scanned computer-readable identifier. Similarly, an item pick-up can be confirmed as well. Accordingly, personnel delivering or picking up an item can place the shipping label in view of the camera in order to automatically trigger the capture of a digital image that includes the computer-readable identifier, and further, to automatically trigger a chain of events: identification and decoding of the computer-readable identifier, locating a particular shipping record associated with the computer-readable identifier, and transmitting the appropriate party a confirmation of the delivery or pickup based on the computer-readable identifier and/or shipping record.

Unlike other technologies, leveraging existing camera-coupled local computing devices allows for seamless confirmation of delivery and pick-up of items, without requiring personnel to take any action beyond placing a package in the view of the camera, for example. The aspects of the invention described herein, thus, provide technological advances by creating a way for back-end carrier infrastructure to interface with local computing devices. Further, aspects of the invention provide an improvement over existing technologies by enabling the back-end carrier infrastructure to globally leverage any number of camera-cooperative local computing devices at end-point locations to electronically capture pick-up and delivery actions, and automatically provide confirmations.

Aspects of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one aspect, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magneto-resistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one aspect, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where aspects are described to use a computer-readable storage medium, other types of computer-readable storage media may be substituted for or used in addition to the computer-readable storage media described above.

As should be appreciated, various aspects of the present invention may also be implemented as methods, apparatus, systems, computing devices, computing entities, and/or the like. As such, aspects of the present invention may take the form of an apparatus, system, computing device, computing entity, and/or the like executing instructions stored on a computer-readable storage medium to perform certain steps or operations. Thus, aspects of the present invention may also take the form of an entirely hardware aspect, an entirely computer program product aspect, and/or an embodiment that comprises combination of computer program products and hardware performing certain steps or operations.

Aspects of the present invention are described below with reference to block diagrams and flowchart illustrations. Thus, it should be understood that each block of the block diagrams and flowchart illustrations may be implemented in the form of a computer program product, an entirely hardware aspect, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary aspects, retrieval, loading, and/or execution may be performed in parallel such that multiple instructions are retrieved, loaded, and/or executed together. Thus, such aspects can produce specifically-configured machines performing the steps or operations specified in the block diagrams and flowchart illustrations. Accordingly, the block diagrams and flowchart illustrations support various combinations of aspects for performing the specified instructions, operations, or steps.

Example System

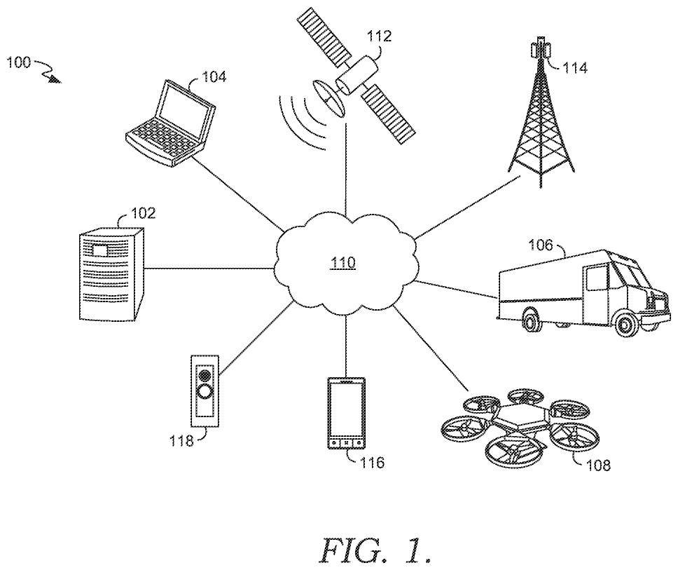

FIG. 1 depicts an example communication environment 100 suitable for implementations of aspects discussed herein. The communication environment 100 includes one or more carrier computing devices. For example, a carrier computing device may be a server 102, a desktop or laptop computing device 104, a manual vehicle computing device 106, and/or an automated vehicle computing device 108.

The carrier computing device(s) may communicate directly or indirectly with one or more of the other carrier computing devices. In some aspects, the carrier computing device(s) may communicate with one another using a network 110. The carrier computing devices(s) may communicate with and/or may exchange information with a location and positioning system that leverages a satellite 112, in some aspects. The carrier computing device(s) may communicate with and/or may exchange information with one or more base stations or cells sites, such as base station 114, in some aspects. In various aspects, the carrier computing device(s) may communicate with a location and positioning system and/or base stations of a telecommunications network to determine accurate, historical, and near real-time location information of other devices in the network 110, as further discussed hereinafter.

In aspects, the carrier computing device(s) may communicate and/or may exchange information, indirectly or directly, with user equipment, such as a wireless communications device 116 and/or a local computing device 118 using the network 110. In some aspects, user equipment is associated with a consumer, an end-user, a consignee, and/or an end-point location (e.g., a business or residential street address, a pick-up or drop-off locker address or locker unit identifier, a retail store identifier). The local computing device 118 may include a smart device, such as a smart home device that includes at least one camera. An example of a smart home device includes a smart doorbell and/or smart lock (e.g., devices for Ring®, Google Nest®, Eufy®, Arlo®, August®, Remo®, Vinint®), a residential monitoring system (e.g., home security computer system) for the interior and/or exterior of the residence, and the like. In one aspect, the local computing device is a smart doorbell, and/or communicates directly or indirectly with a smart doorbell located at the end-point location. As used herein, “end-point location” can, generally, refer to a pick-up location, a delivery location, or a consolidation location.

Accordingly, the local computing device 118 may include an integrated camera and/or may communicate with one or more cameras that monitor the end-point location, such as a residence, retail location, and/or locker structure. The camera may capture images and/or video in black-in-white, color, “night” vision, infrared, and/or other methods. The camera may directly or indirectly communicate with the local computing device 118, for example, to send one or more images captured by the camera to the local computing device 118 for analysis in near real-time with the capture. In some aspects, the camera includes one or more sensors for capturing, collecting, and/or recording visual information as digital data (e.g., images and/or videos). It should be understood that videos are contemplated to be within the scope of this disclosure, although images are generally referred to herein. The visual information may be captured by the camera, used to generate digital images, videos, and/or augmented reality, and stored in any variety of digital file formats or as raw data in memory and/or a data store. In some aspects, visual information is collected by the camera and used to generate digital still images, video, and/or augmented reality, using formats such as 360° images, Joint Photographic Experts Group (JPEG), Motion JPEG (MJPEG), Moving Picture Experts Group (MPEG), Graphics Interchange Format (GIF), Portable Network Graphics (PNG), Tagged Image File Format (TIFF), bitmap (BMP), H.264, H.263, Flash Video (FLV), Hypertext Markup Language 5 (HTML5), VP6, VP8, 4K, and/or the like. In various aspects, one or more of the other components in FIG. 1 may include one or more cameras.

In some aspects, the local computing device 118 includes or interfaces with one or more sensors. The sensor(s) may be configured to sense motion, distance, proximity, weight, or the like. Examples of sensors include types and subtypes such as an optical sensor (e.g., proximity sensing), a photocell sensor, a photoelectric sensor, a laser range finding sensor, a laser trip sensor, a Light Detection and Ranging (LIDAR) sensor, an infrared sensor, an ultrasonic sensor, a magnetic field sensor, a motion sensor, a proximity sensor, a moisture sensor (e.g., water inundation detection, a residential humidifier), a temperature sensor (e.g., a thermostat), and the like. The sensor(s) may provide information in near real-time to the local computing device 118 and/or other components, such as a camera.

The local computing device 118 may, directly or indirectly, exchange data and information with a cloud-based application or service, an Internet-based application or service, and/or a server-based application or service. Accordingly, the local computing device 118 may include a radio and antenna, or a wireless receiver and transmitter, in some aspects. In aspects, the local computing device 118 may communicate using the network 110 and/or other wireless network, or hardwires networks at the end-point location. For example, the local computing device 118 may communicate using peer-to-peer connections, Bluetooth, infrared, and/or other data exchanging technologies. The local computing device 118 may include one or more components such as a network interface and/or telecommunications interface, for example, in order to exchange data and information using the Internet, a web-based application, or a telecommunications network.

Generally, in aspects, the local computing device 118 is a third party device that is not associated with and/or is not controlled by a carrier entity. In contrast, the carrier computing device is associated with a carrier entity, in aspects. For example, the carrier computing device may be controlled by a carrier entity, and/or the carrier computing device may run or execute software that supports services provided by the carrier entity. A “carrier” and “carrier entity” may be a traditional carrier, such as United Parcel Service (UPS), FedEx, DHL, courier services, the United States Postal Service (USPS), Canadian Post, freight companies (e.g. truck-load, less-than-truckload, rail carriers, air carriers, ocean carriers, etc.), and/or the like. However, the term “carrier” and “carrier entity” may also refer to a nontraditional carrier, such as Amazon, Google, Uber, Lyft, ride-sharing services, crowd-sourcing services, retailers, and/or the like.

In some aspects, the carrier computing device(s) may be remotely located from the local computing device 118. The carrier computing device(s) may be a physical server, a group of physical servers, a virtual server, a group of virtual servers, or a combination thereof that are remotely located and that communicate with other components and devices over a backhaul network, the network 110, and/or any other wireless of hardwired network. In other aspects, the carrier computing device(s) may be located locally with the local computing device 118. In such aspects, the carrier computing device(s) could be a mobile computing device controlled by or associated with a carrier entity, such as, for example, a handheld device with a camera and/or a scanner component, in such aspects.

The carrier computing device(s) may be one or more of a distributed server system, desktop computer, laptop computer, mobile device, wireless communication device, user equipment, smartphone, tablet, notebook computer, distributed computing system, console input terminal, gateway, switch, router, processing device, bridge, set-top boxes, relay, access point, base station (e.g., eNodeB, gNodeB, picocell, femtocell), and/or any combination devices or components adapted to perform one or more of the functions, operations, and/or processes described herein. The carrier computing device(s) may include a power source or power supply, a memory, a processor, a bus, a radio transmitter, a transceiver, and/or an antenna, in some aspects. The carrier computing device(s) may include wireless communications capability and/or hardwired connections, adaptors, and/or interfaces. The carrier computing device(s) may be capable of communicating with one or more other computing devices, directly or indirectly, using one or more varied and distinct technologies, standards, and/or protocols for hardwired and/or wireless communications. The carrier computing device(s) may, for example, be capable of exchanging data using 3G, 4G, 5G, Code Division Multiple Access (CDMA), Code Division Multiple Access 2000 (CDMA2000), CDMA 1XA, General Packet Radio Service (GPRS), Universal Mobile Telecommunications System (UMTS), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Bluetooth protocols, Wibree, Home Radio Frequency (HomeRF), Simple Wireless Abstract Protocol (SWAP), wireless universal serial bus (USB) protocols, and/or any other wireless protocol, for example, using the network 110 or any other network.

The terms “computing entity,” “computer,” “computing device.” “device,” “system,” and similar words used interchangeably herein may refer to, for example, one or more computers, computing entities, computing components, computing devices, desktops, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, kiosks, input terminals, servers or server networks (e.g., physical, virtual, or a combination), blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one aspect, these functions, operations, and/or processes can be performed on data, content, information, and/or similar terms used herein interchangeably. A computing device may exchange information with a cloud-based application or service, an Internet-based application or service, and/or to an application or service operating on the one or more customer computing devices. The terms “application,” “tool,” and “service” may be used interchangeably herein to refer to computer program products, computer code, and/or computer executable instructions that may be executed by a processor in order to perform a computerized method.

In aspects, the network 110 may include one or more networks. For example, the network 110 may include one or more, or a plurality of, wireless networks, hardwired networks, telecommunications networks, peer-to-peer networks, distributed networks, and/or any combination thereof. Examples of a network include a telecommunications network (e.g., 3G, 4G, 5G, CDMA, CDMA 1XA, GPRS, EvDO, TDMA, GSM, LTE, and/or LTE Advanced). Additional examples of a network include a wide area network (WAN), a local area network (LAN), a metropolitan area network (MAN), a wide area local network (WLAN), a personal area network (PAN), a campus-wide network (CAN), a storage area network (SAN), a virtual private network (VPN), an enterprise private network (EPN), a home area network (HAN), a Wi-Fi network, a Worldwide Interoperability for Microwave Access (WiMax) network, and/or an ad-hoc (mesh) network. The network 110 may include or may communicate with a physical location component for determining a geographic location of an item, package, parcel, personnel, vehicle, end-point location, etc., by leveraging, for example, a Global Positioning System (GPS), Globalnaya Navigazionnaya Sputnikovaya Sistema (GLONASS), BeiDou Navigation Satellite System (BDS), Global Navigation Satellite System (GNSS or “Galileo”), an indoor position system (IPS), or other positioning systems that leverage non-GPS signals or networks (e.g., signals of opportunity (SOP)).

As such, the communication environment 100 shown in FIG. 1 may include a data store or database (not shown), which may be locally or remotely located in relation to other components. A data store may electronically store information related to carrier operations, including one or more of shipper identity, shipper billing and/or pickup addresses, shipper service level, consignee identity, consignee billing and/or delivery addresses, consignee service level, shipment manifests, invoices, order numbers, shipment values, shipment insurance information, unique package or shipment codes (e.g., 1Z codes) for one or more packages, package dimensions, package weight, routing information, consolidation information, package pre-loading information, packaging tracking and monitoring information (e.g., GPS), shipment workflows, logistics information, transport vehicle information, pre-loading instructions for a package, dispatch plans, and the like. The data store may be accessible to one or more of the components and/or devices discussed above, and as such, information stored in the data store may be searched, referenced, retrieved, indexed, updated, and/or may serve as input to one or more of the components and/or devices of the communication environment 100.

Although not shown in FIG. 1, the carrier computing entity may include or use with one or more input elements, such as a keyboard input, a mouse input, a touch screen/display input, motion input, movement input, audio input, pointing device input, joystick input, keypad input, and/or the like. The carrier computing entity may also include or be in communication with one or more output elements (not shown), such as audio output, video output, screen/display output, motion output, movement output, and/or the like. As will be appreciated, one or more of the carrier computing entity's components may be located remotely from other carrier computing entity components, such as in a distributed system. Furthermore, one or more of the components may be combined and additional components performing functions described herein may be included in the carrier computing entity. Thus, the carrier computing entity can be adapted to accommodate a variety of needs and circumstances. As will be recognized, these architectures and descriptions are provided for exemplary purposes only and are not limiting to the various aspects.

Referring to the FIG. 1, it should be understood that the communication environment 100 shown in FIG. 1 is only one example of a suitable environment, and this example has been simplified for ease of discussion. As such, the placement of various components shown in FIG. 1 is an abstraction such that one or more of the various components may be located or may operate anywhere within the communication environment 100, and the depicted arrangement is only an example. Further, the components shown may be implemented as discrete components, distributed components, or in conjunction with other components, and in any suitable combination and physical or virtual location. Accordingly, other components not shown may also be included within the environment, and one or more of the shown component may be omitted, in various embodiments. Therefore, each of the components of FIG. 1 may be implemented using any type or number of computing devices, in embodiments. It should also be understood that any number of components shown in FIG. 1 are contemplated to be within the scope of the present invention such that each component may be implemented via a single device or multiple devices cooperating in a distributed environment. Accordingly, other components and arrangements may be used additionally or instead of that which is depicted. Further, it should be understood that functions described herein as being performed by one or more components, entities, and/or devices may be carried out by hardware, firmware, and/or software, such that the functions are not limited unless explicitly described as such.

Example Methods

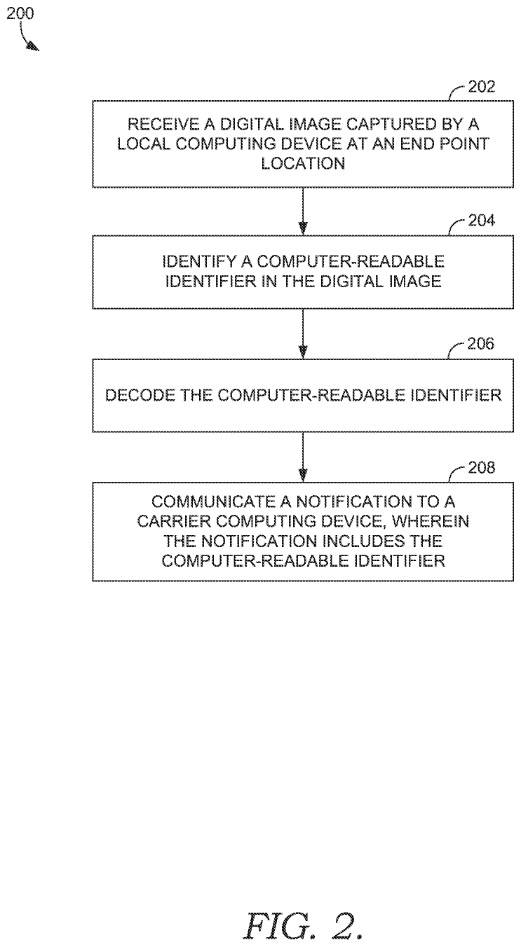

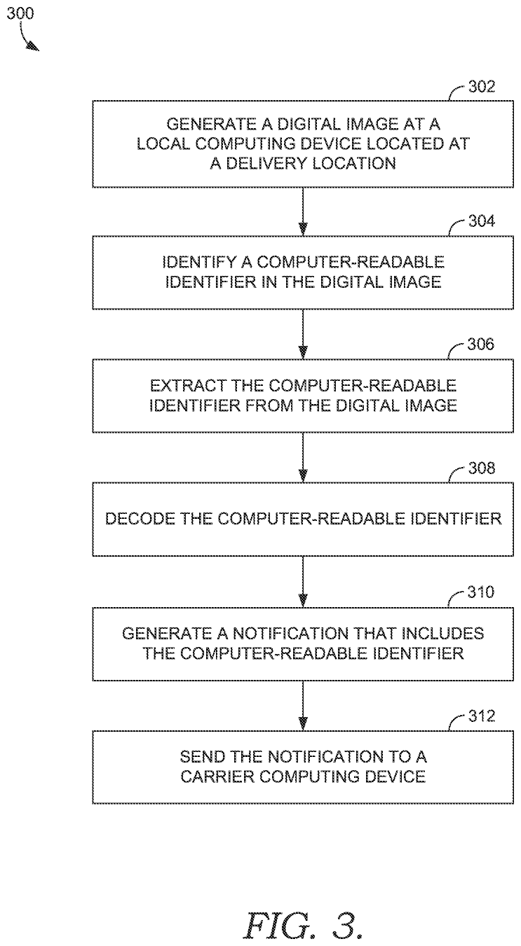

Turning now to FIGS. 2 to 3, methods are discussed that can be performed via one or more of the devices, components, and device/component interactions previously described in the communication environment 100 of FIG. 1. As such, the methods are discussed briefly, though it will be understood that the previous discussion and details described therein can be applicable to aspect of the methods of FIGS. 2 to 3. Additionally, it will be understood that the methods discussed herein can be implemented or performed via the execution of computer-readable instructions stored on computer-readable media, by one or more processors. For example, the methods of FIGS. 2 to 3 may be computer-implemented methods. In various aspects, one or more non-transitory computer-readable storage media having computer-readable instructions or computer-readable program code portions embodied thereon, for execution via one or more processors, may be used to implement and/or perform the methods. In some aspects, computer-readable instructions or computer-readable program code portions may specify the performance one or more of the steps of the methods, and/or may identify particular component(s) of software and/or hardware for performing one or more of the steps of the methods of FIGS. 2 to 3. The computer-readable instructions or computer-readable program code portions may correspond to an application, service, and/or an application programming interface (API), in aspects. In one aspect, the application, service, or API can implement and/or perform the methods of FIGS. 2 to 3. As discussed below, the methods can be performed using software, hardware, component(s), and/or device(s) depicted in the example of FIG. 1.

Additionally, it should be understood from this disclosure that aspects of the methods discussed below may be performed, in whole, or partially, by the local computing device, the carrier computing device, and/or on a network using a physical server or virtual machine. For example, a web-based application or web-based service may be accessed and/or may be at least partially “run” locally by the local computing device. In some instances, the web-based application or web-based service is partially run on the local computing device and is partially run on the carrier computing device. As such, the “location” of a device and/or the location of performance of aspects of the methods may be an abstraction in such instances, for example, where a web-based application is leveraged for implementation of the aspects herein.

FIG. 2 depicts a method 200 is depicted for performing pick-up or delivery confirmations using an optical scan at a local device. Beginning at block 202, a digital image captured by a local computing device at an end-point location is received. For example, the local computing device may include an integrated camera or may be communicatively coupled to one or more cameras at the end-point location. Examples of devices that include a camera include a smart doorbell, smart lock, a security or surveillance camera, and the like. The camera may capture one or more static black-and-white images, color images, infrared images, false color images, and/or may capture video of an area that includes a portion of the end-point location, whether exteriorly or interiorly located. For example, the image may include content depicting a front porch, stairway, or exterior stoop area of a home, an interior lobby or mailbox area of an apartment building, an area proximate an exterior door or interior door leading to a residence or retail location, and/or an area where storage lockers are accessible. The images and/or videos may be processed from raw data and transformed or otherwise formatted as one or more digital images. As used herein, “image” and “video” may be used interchangeably for simplicity and the terms are not to be construed as limiting in kind and/or quantity.

Generally, the camera may monitor or capture images of an area at the end-point location. In some aspects, the camera may capture and generate a digital image, for example, of an item (e.g., a package, parcel, envelope) that is located or in proximity to the end-point location, for example, as being physically located within a field-of-view of the camera. For example, personnel or an unmanned aerial vehicle may approach the camera at the end-point location and physically place the item within the field-of-view of the camera, in order to cause an image of the item to be captured by the camera at the end-point location. In one example, personnel or an unmanned aerial vehicle may physically place an item having an exteriorly located shipping label within the field-of-view of the camera, and further, within one to four feet from the camera. The camera may capture an image of the item, including the shipping label, at that time, for example. It will be understood the distance or proximity between the item and the camera may be tailored and may be dependent on the ability of the camera to obtain high resolution images at specific distances using a zoom-in function. As such, these are only examples and the examples are not to be construed as limiting.

In one aspect, the digital image generated by the camera includes a plurality of pixels that depict the item (e.g., the item itself, a parcel, envelope, or mailer that includes one or more items) and a shipping label. For example, the local computing device may analyze the digital image and identify one or more dimensions and/or physical characteristics that correspond to a shipping label (e.g., a particular height and a width, a color, placement on a surface of a package). In a further aspect, the digital image generated by the camera includes a plurality of pixels that depicts a computer-readable identifier within the shipping label (i.e., the shipping label includes one or more computer-readable identifiers). Accordingly, at block 204, a computer-readable identifier is identified in the digital image. For example, the local computing device may identify one or more computer-readable identifiers present in the content of the digital of image. Additionally or alternatively, the local computing device may identify one or more computer-readable identifiers present in the content of the digital of image by communicating, via one or more networks, with a carrier computing device that provides image analysis software tools/web-based application accessible to the local computing device for identifying the computer-readable identifier within the shipping label, in some aspects. As used herein “content” of an image or digital image refers to the captured field-of-view proximate the end-point. For example, the content may include the item, a package for the item, a shipping label, pick-up or delivery personnel, a carrier vehicle, structures such as a mailbox or sidewalk, and any other persons, items, animals, structures, and the like that are visible within the field-of-view. The local computing device may further identify one or more recognizable graphics, such as a carrier logo located on a vehicle or package or personnel uniform, within the digital image. The local computing device may access and utilize one or more reference images stored in a data store, for example, managed by a carrier computing device, for comparisons and analysis when making identifications of shipping labels, computer readable identifiers, personnel, vehicles, unmanned aerial vehicles, and other objects within the digital images.

The item, shipping label, and computer-readable identifier may be identified by the local computing device, for example, using contrast analysis of one or more groups of neighboring pixels to identify various area(s) in the digital image, using edge detection and/or pattern matching (e.g., match the pattern of the pixels of the computer-readable identifier to one or more reference images, match image features to reference object features), greyscale and/or gradient matching, object-based image analysis (e.g., segmentation and classification), and/or other image analysis recognition technology. In various embodiments, the item, shipping label, and computer-readable identifier are identified in the digital image by the local computing device, as the item pick-up or delivery is occurring, i.e., in near real-time with capture of the digital image by the camera.

Within the content of the digital image itself, some portion of the plurality of pixels may depict the shipping label that is attached to the item, in aspects. In further aspects, a first portion of the plurality of pixels may depict one or more computer-readable identifiers that are included in the shipping label. In some aspects, the one or more computer-readable identifiers may be identified by the local computing device based on type. In various embodiments the local computing device can distinguish between different computer-readable identifier types. Examples of computer-readable identifier types include barcodes, Maxi-Codes, QR codes, 1Z codes, composite codes, Quick Response (QR) codes, Aztec Codes, DataMatrix, Postnet, EAN-8, linear-type or two dimensional-type, and further, various types can utilize character sets of numbers, symbols, alphabetical letters, spaces, ASCII, FNCI, ESI, and/or control codes. The local computing device recognizes that a portion of the content in the digital image corresponds to a barcode, in one example. In another example, the local computing device recognizes that a portion of the content in the digital image corresponds to a 1Z code. In one example, the local computing device can identify that the shipping label includes multiple computer-readable identifiers, such as, for example, one barcode, one MaxiCode, and one QR code, based on an analysis of the digital images, the relative dimensions of the multiple computer-readable identifiers, and the placement of the computer-readable identifiers within the shipping label.

At block 206, the computer-readable identifier is decoded. In aspects, the computer-readable identifier is decoded by the local computing device located at the end-point location as the item pick-up or delivery is occurring, or nearly concurrently with, i.e., in near real-time with capture of the digital image by the camera. The local computing device may determine that the computer-readable identifier encodes information or data that uniquely identifies a particular item, shipment for the item, and/or tracking number for the item or shipment, in aspects. In some aspects, when decoding the computer-readable identifier, the local computing device may access, search for, or reference one or more electronic communications, such as emails for an order confirmation and/or shipment confirmation information, text messages with order confirmation and/or shipment confirmation information, and/or notifications or messages in a carrier-provided account (e.g., UPS MyChoice) that includes order confirmation and/or shipment confirmation information. The one or more electronic communications may include a shipment number, a tracking number, an invoice number, and/or a receipt reference number, in aspects. The local computing device may store or may have remote access, for example, via a network, to a data store and/or electronic communications that include a shipment confirmation, order confirmation, a shipment number, a tracking number, an invoice number, or a receipt reference number that is related to or corresponds to the item. Then, when decoding the computer-readable identifier, the local computing device may determining whether the computer-readable identifier in the digital image includes the shipment number, the tracking number, the invoice number, or the receipt reference number, in aspects, referenced in the data store, electronic communications, and/or the carrier-provided account. When the computer-readable identifier in the digital image is determined to correspond to or match a shipment number, tracking number, invoice number, receipt reference number or the like, the local computing device may determine that a notification confirming delivery (or pick-up) of the item is to be generated and provided to one or more entities, such as a carrier entity, personnel, a customer, a consignee of the item, and/or an entity associated with the end-point location, in various aspects. In aspects, a notification may be generated by the local computing device. The notification may be an electronic communication such as an email, a text message, an automated voicemail, and/or a token, in various aspects. In aspects, the notification includes the computer-readable identifier. In some aspects, the notification includes one or more of a shipment confirmation, order confirmation, a shipment number, a tracking number, an invoice number, or a receipt reference number that are related to or correspond to the item. In yet another aspect, the notification includes the computer-readable identifier and a shipment confirmation, order confirmation, a shipment number, a tracking number, an invoice number, or a receipt reference number that are related to or correspond to the item. The notification may include, in some aspects, the digital image in its entirety, or a portion of the digital image. For example, the notification may include a portion of the pixels that depict the shipping label of the item in the digital image. In one example, the notification may include a first portion of the pixels that depict the computer-readable identifier of the shipping label of the item in the digital image. In another example, at least a portion of the digital image is included in the notification, for example, so that the area that includes the item and that is depicted in the digital image of the field-of-view of the camera may be visually recognizable by a customer, if viewed.

At block 208, the notification is communicated to a carrier computing device, for example, wherein the notification includes the computer-readable identifier. In aspects, the local computing device may send the notification via a network for receipt by a carrier computing device. The notification may be communicated by the carrier computing device over one or more networks to the carrier computing device and/or to a consignee device as the item pick-up or delivery is occurring, i.e., in near real-time with capture of the digital image by the camera. For example, local computing device may send the notification via a network for receipt by a carrier computing device that is a remote server. In one such example, the notification may be sent to provide a confirmation to a remote server that the pick-up or drop-off of the item has been documents and logged by the local computing device. The remote server may relay, forward, and/or send the notification to a customer, for example, and may provide a notification to a customer of the pick-up or drop-of o the item through a carrier-based account, in aspects. In another example, the local computing device may send the notification via a network for receipt by a carrier computing device that is a mobile device associated with personnel, for example, associated with the pick-up or drop-off of the item. In such an example, the notification may be sent to the mobile device as a confirmation to the personnel that the pick-up or drop-off of the item has been documents and logged by the local computing device. In various aspects, the notification includes, or acts as, a confirmation that the computer-readable identifier in the digital image includes the shipment number, the tracking number, the invoice number, or the receipt reference number referenced in the electronic communication.

Accordingly, using the method 200, the camera obtaining and generating a digital image of a computer-readable identifier in a shipping label, combined with the local computing device decoding the computer-readable identifier, is such that the computer-readable identifier is “scanned” and the local computing device facilitates sending a notification that confirms pick-up or delivery of the item, in aspects.

Continuing to FIG. 3, a method 300 is depicted for performing pick-up or delivery confirmations using an optical scan at a local device. In accordance with the method 300, at block 302, a digital image is generated at a local computing device located at an end-point location, as previously discussed. As discussed above, a camera may obtain an image or video, or a series of sequentially captured images of an item that is being picked up or dropped off at the end-point location. For example, delivery personnel or an unmanned aerial vehicle may physically place an item having an exteriorly located shipping label within the field-of-view of the camera, and further, within one to four feet from the camera. The camera may capture an image of the item, including the shipping label, for example. More specifically, in some aspects, the shipping label may be placed at or less than three feet or one meter of the camera, such that the delivery personnel or an unmanned aerial vehicle may physically place an item having an exteriorly located shipping label within the field-of-view of the camera and/or may trigger the camera to obtain an image of the shipping label due to the increase in proximity of the item. In some aspects, the camera may be used with a motion sensor, a proximity sensor, and/or a microphone in order to initiate the image being captured. For example, personnel or an unmanned aerial vehicle may physically place the shipping label that includes a computer-readable identifier at or within 10 feet of the camera, within the field-of-view of the camera, in order to cause the camera to initiate the capture of an image or video. In another aspect, personnel or an unmanned aerial vehicle may physically place the shipping label that includes a computer-readable identifier at or within 10 feet of the camera, within the field-of-view of the camera, and issue an audible sound or dialog (e.g., “Alexa, please take a photo” or “Ok Google, take a picture”) in order to cause the camera to initiate the capture of an image or video. In some aspects, the local computing device may cause a speaker to issue an audible noise or tone, or cause a light to flash, wherein the audible noise or visible stimulus may be detected by the personnel or the unmanned aerial vehicle as an indication that an image or video was obtained by the camera in response to a verbal instruction.

Additionally or alternatively to the item being placed within the field-of-view of the camera, personnel, an unmanned aerial vehicle, and/or a delivery vehicle (e.g., automobile, delivery truck) may also be within the field-of-view of the camera. The camera may obtain an image or video, or a series of sequentially captured images of the personnel, the unmanned aerial vehicle, and/or the delivery vehicle that is also within the field-of-view for this instance of the item being picked up or dropped off at the end-point location.

At block 304, a computer-readable identifier is identified in the digital image. In some aspects, the local computing device and/or a processor coupled to the camera identifies a grouping of pixels in the digital image that depict the shipping label. In one aspects, the local computing device and/or a processor coupled to the camera identifies a grouping of pixels in the digital image that specifically depict a computer-readable identifier. In yet another aspect, the local computing device and/or a processor coupled to the camera identifies a grouping of pixels in the digital image that depict the shipping label, and then, identify a second portion of pixels in that grouping of pixels that depict a computer-readable identifier. The computer-readable identifier may be automatically identified in response to capture of the digital image and/or based on receipt of the digital image by the local computing device.

At block 306, the computer-readable identifier is extracted from the digital image. In aspects, the local computing device extracts a portion of pixels that depict the computer-readable identifier while leaving a portion of remaining pixels that depict other content (i.e., non-shipping label portions, non-identifier portions, background, other areas near the end-point location) in the digital image that correspond to the field-of-view of the camera.

At block 308, the computer-readable identifier is decoded. In aspects, the local computing device may decode the computer-readable identifier as previously discussed. Additionally, based on decoding the computer-readable identifier, a shipment identifier may be identified that is associated with the package/item captured in the digital image. In one aspect, the shipment identifier is a tracking number that uniquely identifies one package in a shipment, or that uniquely identified a specific group of associated packages that are related to one shipment or one invoice.

At block 310, a notification that includes the computer-readable identifier is generated. Then, at block 3012, the notification is sent to a carrier computing device. As previously discussed, the notification may be generated and provided to a carrier computing device, wherein the notification provides a confirmation of pick-up or delivery of the item captured in the digital image and decoding (“scan”) of the computer-readable identifier of the shipping label for the item.

Additionally or alternatively to extracting and decoding the computer-readable identifier to locate the shipment identifier and provide a confirmation of delivery, digital images that include the personnel, the unmanned aerial vehicle, and/or the delivery vehicle within the field-of-view of the camera may also be analyzed to verify and/or confirm the pick-up or delivery of the item by a carrier-approved or “trusted” entity. For example, the personnel, the unmanned aerial vehicle, and/or the delivery vehicle in the digital images may be used to verify that a carrier-approved or “trusted” entity is performing a delivery of the item. In another example, the personnel, the unmanned aerial vehicle, and/or the delivery vehicle in the digital images may be used to verify that a carrier-approved or “trusted” entity is picking up the item, e.g., as tender to the carrier entity. In yet another example, the personnel, the unmanned aerial vehicle, and/or the delivery vehicle in the digital images may be used to verify in an instance when the computer-readable identifier cannot be identified in the digital image, cannot be extracted from the digital image, or cannot be decoded (e.g., shipment identifier cannot be verified, located, or matched to an electronic record of the carrier entity and/or consignee entity).

In order to determine whether the pick-up or delivery of the item is performed by a carrier-approved or “trusted” entity, pixels in the digital image (e.g., image, video, and/or series of sequentially captured images) analyzed to location a portion or entirety of one or more of: a human body, a human face, a vehicle, an unmanned aerial vehicle. In some aspects, only those pixels that do not correspond to the computer-readable identifier (whether decoded or not decoded) are analyzed. By identifying a grouping of pixels in the digital image that correspond to a human body, a vehicle, or an unmanned aerial vehicle, that grouping can further analyzed to locate a subset of contiguous pixels that correspond to a carrier-specific symbol, graphic, or visual indicators (e.g., a graphic, letter(s), a logo, a particular combination of colors, a specific shape(s), a particular relative arrangement of specific colors within the pixels, and/or a particular relative arrangement of defined shapes in specific colors within the pixels).

For example, the subset of contiguous pixels may be identified as letter(s) and/or a logo that is specific to a particular carrier-entity, which is identified based on the combination and arrangement of colors and/or shapes in the subset of contiguous pixels in the digital image. The logo may be identified as being located on a personnel uniform, on a surface of a package containing the item (e.g., logo printed on the outer box containing the item), on a label on the package/item, on an exterior of a delivery vehicle, and/or on the exterior of the unmanned aerial vehicle. In one example, the subset of contiguous pixels may correspond to a carrier-specific uniform within the grouping of pixels that correspond to a human body. The uniform may be identified in the subset of contiguous pixels based on the color and “placement” or correspondence to at least some of the pixels that are also recognized as corresponding to at least a portion of a human body within the digital image. Additionally or alternatively, facial recognition technology may be used to identify the subset of contiguous pixels that correspond to a human face, for example, within a grouping of pixels that are recognized as corresponding to at least a portion of the human body. For example, the facial recognition technology may be further utilized to identify a specific person in the digital image based on comparisons to a database of current personnel authorized for pick-up and/or delivery by the carrier entity.

In some instances, verification that the pick-up or delivery of the item is performed by a carrier-approved or “trusted” entity may be determine only by the co-presence of more than one carrier-specific indicator within the digital image. For example, verification that the pick-up or delivery of the item is being handled by a carrier-approved or “trusted” entity may be determined only when at least a carrier logo and a personnel uniform are determined to be present in the digital image. In another example, verification that the pick-up or delivery of the item is performed by a carrier-approved or “trusted” entity may be determined only when at least carrier logo and a specific identity of personnel, recognized via facial recognition, are determined to be present in the digital image. In various aspects, any combination of two or more carrier-specific recognized indicators could be used to determine that the pick-up or delivery is authorized as performed by carrier-approved or “trusted” entity. In another aspect, one or more predefined combinations of two or more carrier-specific indicators within the digital image may be used to determine that the pick-up or delivery is authorized as performed by carrier-approved or “trusted” entity.

Regarding FIGS. 1 through 3, it will be understood by those of ordinary skill in the art that the environment(s), system(s), and/or methods(s) depicted are not intended to limit the scope of use or functionality of the present aspects. Similarly, the environment(s), system(s), and/or methods(s) should not be interpreted as imputing any dependency and/or any requirements with regard to each component, each step, and combination(s) of components or step(s) illustrated therein. It will be appreciated by those having ordinary skill in the art that the connections illustrated the figures are contemplated to potentially include methods, hardware, software, and/or other devices for establishing a communications link between the components, devices, systems, and/or entities, as may be utilized in implementation of the present aspects. As such, the absence of component(s) and/or steps(s) from the figures should be not be interpreted as limiting the present aspects to exclude additional component(s) and/or combination(s) of components. Moreover, though devices and components in the figures may be represented as singular devices and/or components, it will be appreciated that some aspects can include a plurality of devices and/or components such that the figures should not be considered as limiting the number of a devices and/or components.

It is noted that aspects of the present invention described herein with reference to block diagrams and flowchart illustrations. However, it should be understood that each block of the block diagrams and/or flowchart illustrations can be implemented in the form of a computer program product, an entirely hardware aspect, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code can be performed sequentially such that one instruction is retrieved, loaded, and executed at a time. In some aspects, retrieval, loading, and/or execution can be performed in parallel such that multiple instructions are retrieved, loaded, and/or executed together. Thus, such aspects can produce specifically-configured machines performing the steps or operations specified in the block diagrams and flowchart illustrations. Accordingly, the block diagrams and flowchart illustrations support various combinations of aspects for performing the specified instructions, operations, or steps.

Additionally, as should be appreciated, various aspects of the present disclosure described herein can also be implemented as methods, apparatus, systems, computing devices/entities, computing entities, and/or the like. As such, aspects of the present disclosure can take the form of an apparatus, system, computing device, computing entity, and/or the like executing instructions stored on a computer-readable storage medium to perform certain steps or operations. However, aspects of the present disclosure can also take the form of an entirely hardware aspect performing certain steps or operations.

Thus, many different arrangements of the various components depicted, as well as components not shown, are possible without departing from the scope of the claims below. Aspects of our technology have been described with the intent to be illustrative rather than restrictive. Alternative aspects will become apparent readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

1. One or more non-transitory computer-readable storage media having computer-readable instructions embodied therein for execution by one or more processors to perform a method, the method comprising:
receiving a digital image captured by a local computing device at an end-point location;
identifying a computer-readable identifier in the digital image;
decoding the computer-readable identifier; and
communicating a notification to a carrier computing device, wherein the notification includes the computer-readable identifier.

2. The media of claim 1, wherein the digital image includes a plurality of pixels that depict a shipping label having the computer-readable identifier.

3. The media of claim 2, wherein a first portion of the plurality of pixels depicts the computer-readable identifier, and wherein the computer-readable identifier is identified as being one or more of a barcode, a Maxi-Code, a QR code, or a 1Z code.

4. The media of claim 1, wherein decoding the computer-readable identifier comprises referencing an electronic communication that includes a shipment number, a tracking number, an invoice number, or a receipt reference number.

5. The media of claim 4, wherein decoding the computer-readable identifier comprises determining that the computer-readable identifier in the digital image includes the shipment number, the tracking number, the invoice number, or the receipt reference number referenced in the electronic communication.

6. The media of claim 5, further comprising generating the notification that includes the computer-readable identifier.

7. The media of claim 6, wherein the notification further comprises a confirmation that the computer-readable identifier in the digital image includes the shipment number, the tracking number, the invoice number, or the receipt reference number referenced in the electronic communication.

8. The media of claim 1, wherein the carrier computing device is a wireless communication device that is associated with delivery personnel.

9. The media of claim 1, wherein the carrier computing device is a remote server.

10. One or more non-transitory computer-readable storage media having computer-readable instructions embodied therein for execution by one or more processors to perform a method, the method comprising:
generating a digital image at a local computing device located at a delivery location;
identifying a computer-readable identifier in the digital image;
extracting the computer-readable identifier from the digital image;
decoding the computer-readable identifier;
generating a notification that includes the computer-readable identifier; and
sending the notification to a carrier computing device.

11. The media of claim 10, wherein the digital image includes a plurality of pixels that depict a shipping label having the computer-readable identifier.

12. The media of claim 11, wherein a first portion of the plurality of pixels depicts the computer-readable identifier, and wherein the computer-readable identifier is identified as being one or more of a barcode, a Maxi-Code, a QR code, or a 1Z code.

13. The media of claim 10, wherein decoding the computer-readable identifier comprises referencing an electronic communication that includes a shipment number, a tracking number, an invoice number, or a receipt reference number.

14. The media of claim 13, wherein decoding the computer-readable identifier comprises:
determining that the computer-readable identifier includes one or more of a barcode, a Maxi-Code, a QR code, or a 1Z code; and
determining the one or more of the barcode, the Maxi-Code, the QR code, or the 1Z code in the digital image corresponds to one or more of the shipment number, the tracking number, the invoice number, or the receipt reference number referenced in the electronic communication.

15. The media of claim 14, wherein the notification further comprises a confirmation that the computer-readable identifier in the digital image includes the shipment number, the tracking number, the invoice number, or the receipt reference number referenced in the electronic communication.

16. A system comprising:
a local computing device communicatively coupled to a network and running a computer application;
a camera communicatively coupled to the local computing device; and
a carrier computing device communicatively coupled to the network,
wherein the local computing device:
generates a digital image using the camera located at a delivery location;
identifies a computer-readable identifier in the digital image;
extracts the computer-readable identifier from the digital image;
decodes the computer-readable identifier using the computer application;
generates a notification that includes the computer-readable identifier; and
sends the notification to the carrier computing device via the network.
